(19) United States
(12) Patent Application Publication
(10) Pub. No.: US 2009/0208179 A1
(43) Pub. Date: Aug. 20, 2009

(54) Analog video signal generation circuit, analog composite video signal generation method, analog signal synthesizing circuit, analog signal synthesizing method, semiconductor integrated circuit, and video equipment

(76) Inventor: Heiji Ikoma, Nara, (JP)

Correspondence Address: MCDERMOTT WILL & EMERY LLP, 600 13TH STREET, NW, WASHINGTON, DC, 20005-3096, US

(21) Appl. No.: 11/918,363

(22) PCT Filed: Jan. 30, 2007
(86) PCT No.: PCT/JP2007/051488

§ 371 Date: Oct. 12, 2007

(30) Foreign Application Priority Data
Jul. 25, 2006 (JP) 2006-202100

(51) Int. Cl. H04N 9/04

(52) U.S. Cl. 386/1

(57) ABSTRACT

In an analog video signal generation circuit, an inverting output terminal NDAOUT4 of a first current-steering differential-output D/A converter DAC4 and an inverting output terminal NDAOUT5 of a second current-steering differential-output D/A converter DAC5 are connected together, and the connection point thereof is connected to a current-to-voltage converter RL6 and to the input terminal of an inverting amplifier AMP. The output terminal of the inverting amplifier AMP is connected with a first video signal output terminal COMPout. This structure uses no adders and thus can reduce the price of video equipment, while using the current-steering differential-output D/A converters DAC4 and DAC5 so that currents consumed by the D/A converters are used effectively. Thus, the avoidance of the use of adders allows the component cost to be reduced, while the effective use of currents consumed in the current-steering D/A converters leads to reduction in power consumption.

### TECHNICAL FIELD

The present invention relates to an analog video signal generation circuit and video equipment including the analog video signal generation circuit, and allows a composite signal (a COMP signal) to be synthesized from a luminance signal (a Y signal) and a chroma signal (a C signal), for example, while enabling currents consumed by D/A converters to be used effectively, so as to implement video equipment at lower cost.

### BACKGROUND ART

Conventional analog video signal generation circuits will be described with reference to FIGS. 3 to 5.

FIG. 3 is a schematic diagram illustrating a first circuit configuration of a conventional analog video signal generation circuit. This technique is described in Patent Document 1 and 2.

In FIG. 3, a D/A converter DAC1 is a current-steering D/A converter and has digital input terminals DY0 to DYn and an analog output terminal DAOUT1. The analog output terminal DAOUT1 is connected to a current-to-voltage converter RL1 interposed between the analog output terminal DAOUT1 and a GND power source. Furthermore, the analog output terminal DAOUT1 is connected with one input terminal of an adder MIXER and then connected with an analog video signal output terminal Yout.

Likewise, a D/A converter DAC2 is a current-steering D/A converter and has digital input terminals DC0 to DCn and an analog output terminal DAOUT2. DAOUT2 is connected to a current-to-voltage converter RL2 interposed between DAOUT2 and the GND power source. Furthermore, DAOUT2 is connected with the other input terminal of the adder MIXER and then connected with an analog video output terminal Cout. The output terminal of the adder MIXER is connected to an analog video output terminal COMPout.

The D/A converters DAC1 and DAC2 are formed in a semiconductor integrated circuit 1 together with digital circuits, etc.

Next, the operations thereof will be described.

A set of n+1-bit digital luminance signals (Y signal) is input to the digital input terminals DY0 to DYn, and an analog Y signal current corresponding to the digital signals is output from the terminal DAOUT1. The analog Y signal current is then converted into an analog Y signal voltage by the output load resistor RL1 serving as a current-to-voltage converter, and the analog Y signal voltage is output from the analog video signal output terminal Yout.

Likewise, a set of n+1-bit digital chroma signals (C signal) is input to the digital input terminals DC0 to DCn, and an analog C signal current corresponding to the digital signals is output from the terminal DAOUT2. The analog C signal current is then converted into an analog C signal voltage by the output load resistor RL2 serving as a current-to-voltage converter, and the analog C signal voltage is output from the analog video signal output terminal Cout.

Furthermore, the analog Y signal voltage and the analog C signal voltage are input to the adder MIXER where the analog Y signal voltage and the analog C signal voltage are synthesized into a composite signal (COMP signal) voltage, which is output from the analog video signal output terminal COMPout.

The analog Y signal and the analog C signal output in this manner are used in a pair as a video signal for display on a TV or the like. The composite signal is also used as a video signal for display on a different TV or the like.

Next, FIG. 4 is a schematic diagram illustrating a second circuit configuration of the conventional analog video signal generation circuit. This technique is described in Patent Document 1.

In FIG. 4, a D/A converter DAC1 is a current-steering D/A converter and has digital input terminals DY0 to DYn and an analog output terminal DAOUT1. The analog output terminal DAOUT1 is connected to a current-to-voltage converter RL1 interposed between the analog output terminal DAOUT1 and the GND power source, and then connected with an analog video signal output terminal Yout.

Likewise, a D/A converter DAC2 is a current-steering D/A converter and has digital input terminals DC0 to DCn and an analog output terminal DAOUT2. The analog output terminal DAOUT2 is connected to a current-to-voltage converter RL2 interposed between the analog output terminal DAOUT2 and the GND power source, and then connected with an analog video output terminal Cout.

Furthermore, a D/A converter DAC3 is a current-steering D/A converter and has digital input terminals DCOMP0 to DCOMPn and an analog output terminal DAOUT3. The analog output terminal DAOUT3 is connected to a current-to-voltage converter RL3 interposed between the analog output terminal DAOUT3 and the GND power source, while the analog output terminal DAOUT3 is also connected with an analog video output terminal COMPout. The D/A converters DAC1 to DAC3 are formed in a semiconductor integrated circuit 2 together with digital circuits, etc.

Next, the operations thereof will be described.

A set of n+1-bit digital luminance signals (Y signal) is input to the digital input terminals DY0 to DYn, and an analog Y signal current corresponding to the digital signals is output from the analog output terminal DAOUT1. The analog Y signal current is then converted into an analog Y signal voltage by the output load resistor RL1 serving as a current-to-voltage converter, and the analog Y signal voltage is output from the analog video signal output terminal Yout.

Likewise, a set of n+1-bit digital chroma signals (C signal) is input to the digital input terminals DC0 to DCn, and an analog C signal current corresponding to the digital signals is output from the analog output terminal DAOUT2. The analog C signal current is then converted into an analog C signal voltage by the output load resistor RL2 serving as a current-to-voltage converter, and the analog C signal voltage is output from the analog video signal output terminal Cout.

Furthermore, a set of n+1-bit digital composite signals (COMP signal), generated in video equipment, a DVD device, or the like together with the digital luminance signal (Y signal) and the digital chroma signal (C signal), is input to the digital input terminals DCOMP0 to DCOMPn, and an analog COMP signal current corresponding to the digital signals is output from the analog output terminal DAOUT3. The analog COMP signal current is then converted into an analog COMP signal voltage by the output load resistor RL3 serving as a current-to-voltage converter, and the analog COMP signal voltage is output from the analog video signal output terminal COMPout.

The analog Y signal and the analog C signal output in this manner are used in a pair as a video signal for display on a TV or the like. The analog COMP signal is also used as a video signal for display on a different TV or the like.

The current-steering D/A converters DAC1 to DAC3 used in the above-described circuit are single-ended output D/A converters, and an example thereof is illustrated in FIG. 5.

FIG. 5 shows an example of the D/A converter DAC1. Input digital signals are decoded by a decoder DECODER to control signals (S0, /S0) to (Sm, /Sm), and the control signals (S0, /S0) to (Sm, /Sm) control a plurality of differential switches to thereby perform switching so as to determine whether each of the currents from current sources IS0 to ISm is passed to the analog output terminal DAOUT1 or to GND. When the currents are not output to the analog output terminal DAOUT1, the currents from the current sources IS0 to ISm flow directly to GND and are thus not consumed by the output load resistor RL1.

Patent Document 1: Japanese Utility Model Registration Publication No. 2600036 (FIGS. 1 and 2)

Patent Document 2: Specification and drawings (FIGS. 2 and 4) of U.S. Pat. No. 4,652,938

### DISCLOSURE OF THE INVENTION

Problems that the Invention Intends to Solve

As described previously, the first circuit configuration of the conventional analog video signal generation circuit requires the expensive adder having the complex structure, while the second circuit configuration needs the three D/A converters. The component cost is thus increased, leading to a problem that the video equipment incorporating the conventional analog video signal generation circuit becomes expensive.

At the same time, the conventional analog video signal generation circuit has another problem that the currents from the non-selected current sources flow directly to GND in the single-ended current-steering D/A converters and thus the currents are not used effectively.

The present invention solves these problems with the conventional analog video signal generation circuit, and an object of the present invention is to reduce the component cost of an analog video signal generation circuit and hence the price of video equipment, while enabling currents consumed by D/A converters to be used effectively.

### Means for Solving the Problems

In order to achieve the objects, according to the present invention, in a case where an analog signal is synthesized from two kinds of digital signals, for example, only two current-steering D/A converters are provided and structured as differential-output D/A converters each having a non-inverting output terminal and an inverting output terminal. And, as is usual, the non-inverting output terminals of the D/A converters are used to output an analog luminance signal (a Y signal) and an analog chromo signal (a C signal), respectively, for example, while the inverting or non-inverting output terminals of the two D/A converters are connected together, so that currents from those inverting or non-inverting output terminals are added together and the resultant current is then subjected to current-to-voltage conversion and to inverting or non-inverting amplification.

Specifically, an inventive analog video signal generation circuit includes: a first current-steering differential-output D/A converter, to which a first set of video signals is input; a second current-steering differential-output D/A converter, to which a second set of video signals is input; and a first current-to-voltage converter and an inverting or non-inverting amplifier, each connected to a connection point at which non-inverting or inverting output terminals of the first and second current-steering differential-output D/A converters are connected together, wherein an output terminal of the inverting or non-inverting amplifier is a first video signal output terminal for outputting a composite video signal obtained by synthesis from the first and second sets of video signals.

In the inventive video signal generation circuit, the first video signal is a set of digital luminance signals, the second video signal is a set of digital chroma signals, and the composite video signal is an analog composite signal.

In the inventive video signal generation circuit, either the non-inverting or inverting output terminal of the first differential-output D/A converter that is not connected to the connection point is connected to a second current-to-voltage converter and to a second video signal output terminal; and either the non-inverting or inverting output terminal of the second differential-output D/A converter that is not connected to the connection point is connected to a third current-to-voltage converter and to a third video signal output terminal.

In the inventive video signal generation circuit, the first differential-output D/A converter converts a set of digital luminance signals into an analog luminance signal; the second differential-output D/A converter converts a set of digital chroma signals into an analog chroma signal; and the first, second, and third video signal output terminals simultaneously output the analog composite signal, the analog luminance signal, and the analog chroma signal, respectively.

An inventive analog video signal generation circuit is formed on a semiconductor integrated circuit and includes three or more current-steering D/A converters to which three or more sets of digital video signals are input, of the three or more current-steering D/A converters, first and second current-steering D/A converters being both differential-output D/A converters; and a first current-to-voltage converter and an inverting or non-inverting amplifier, each connected to a connection point at which non-inverting or inverting output terminals of the first and second current-steering differential-output D/A converters are connected together, wherein an output terminal of the inverting or non-inverting amplifier is a first video signal output terminal for outputting a video signal obtained by analog synthesis in which an analog video signal is synthesized from the digital video signals input to the current-steering D/A converters.

An inventive analog composite video signal generation method includes the steps of: generating an inverted analog luminance signal current from a set of digital luminance signals and generating an inverted analog chroma signal current from a set of digital chroma signals; thereafter adding the inverted analog luminance signal current and the inverted analog chroma signal current together; and subjecting the current obtained by the addition to current-to-voltage conversion and then to inverting amplification, thereby generating an analog composite video signal.

An inventive analog signal synthesizing circuit includes: a plurality of current-steering differential-output D/A converters to which a plurality of digital signals are input; and a resistor for current-to-voltage conversion and an inverting or non-inverting amplifier, each connected to a connection point at which non-inverting or inverting output terminals of the plurality of current-steering differential-output D/A converters are connected together, wherein an output terminal of the inverting or non-inverting amplifier is an analog signal output terminal for outputting an analog signal obtained by analog synthesis in which an analog signal is synthesized from the digital signals input to the current-steering differential-output D/A converters.

An inventive analog signal synthesizing method includes the steps of: generating a plurality of inverted analog signal currents by subjecting a plurality of digital signals to digital-to-analog conversion and to inversion; thereafter adding the plurality of inverted analog signal currents together; and subjecting the current obtained by the addition to current-to-voltage conversion and then to inverting amplification, thereby generating an analog signal.

An inventive analog signal synthesizing method includes the steps of: adding a first inverted analog signal current and a second inverted analog signal current; and thereafter subjecting the current obtained by the addition to current-to-voltage conversion and then to inverting amplification, thereby generating an analog signal.

An inventive semiconductor integrated circuit includes the analog video signal generation circuit described above.

Inventive video equipment includes the analog video signal generation circuit described above.

As described above, in the inventive analog video signal generation circuits and the like, an inverted analog luminance signal (Y signal) current, for example, from the inverting output terminal of the first current-steering differential-output D/A converter and an inverted analog chroma signal (C signal) current, for example, from the inverting output terminal of the second current-steering differential-output D/A converter are added together. The current obtained by the addition is then converted into a voltage by the current-to-voltage converter, and the obtained voltage is subjected to inverting or non-inverting amplification by the inverting or non-inverting amplifier, thereby generating an analog composite signal (COMP signal), for example. Thus, the inventive analog video signal generation circuits and the like do not need to use expensive adders, while utilizing the currents from the inverting output terminals of the two current-steering differential-output D/A converters, in contrast to the current flowing directly to GND in the conventional single-ended current-steering D/A converters shown in FIG. 5, whereby the currents consumed in the D/A converters are used effectively.

### EFFECTS OF THE INVENTION

As described previously, since the analog video signal generation circuits and the like according to the present invention are capable of synthesizing an analog signal without using any adders and without wasting the currents flowing directly to GND in current-steering D/A converters, the component cost is reduced, and the currents consumed in the current-steering D/A converters are used effectively to thereby reduce power consumption, while the current-steering D/A converters having the same capacity as the conventional ones are used.

### BRIEF DESCRIPTION OF DRAWINGS

FIG. 1 is a schematic diagram illustrating an analog video signal generation circuit according to a first embodiment of the present invention.

FIG. 2 is a schematic diagram showing an example of the circuitry of a current-steering differential-output D/A converter.

FIG. 3 is a schematic diagram illustrating a conventional analog video signal generation circuit.

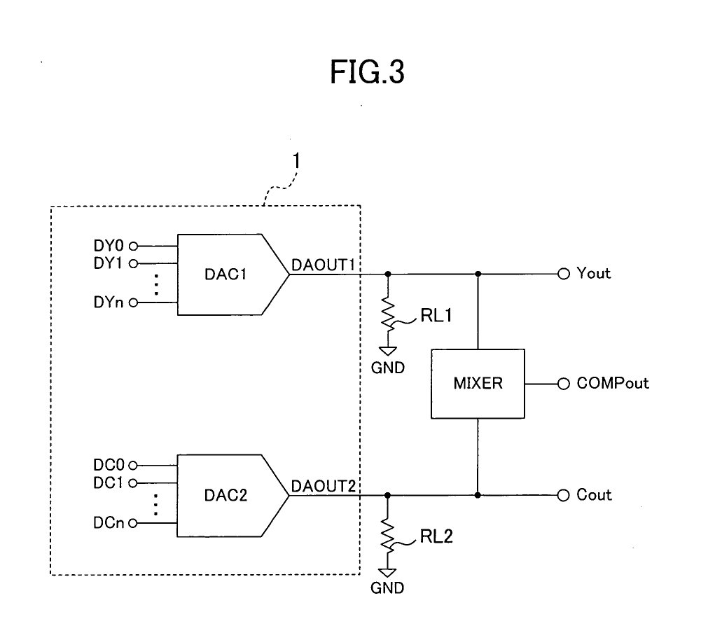

FIG. 4 is a schematic diagram illustrating another conventional analog video signal generation circuit.

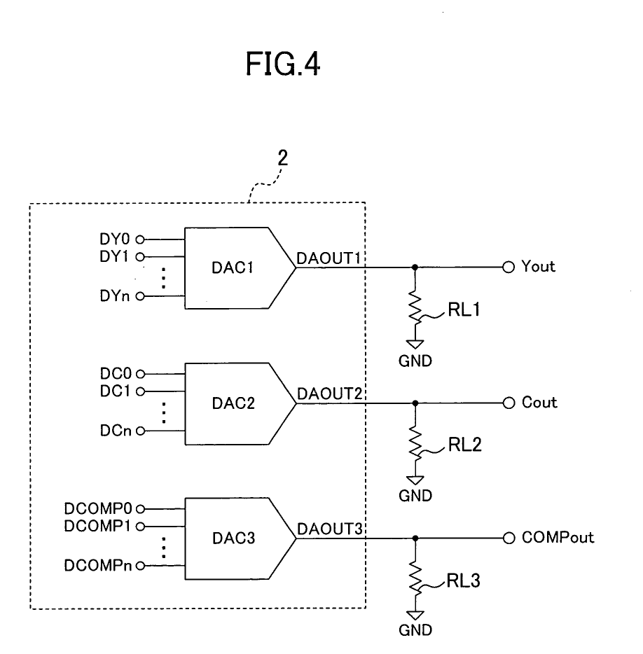

FIG. 5 is a schematic diagram illustrating an example of the circuitry of a conventional single-ended current-steering D/A converter.

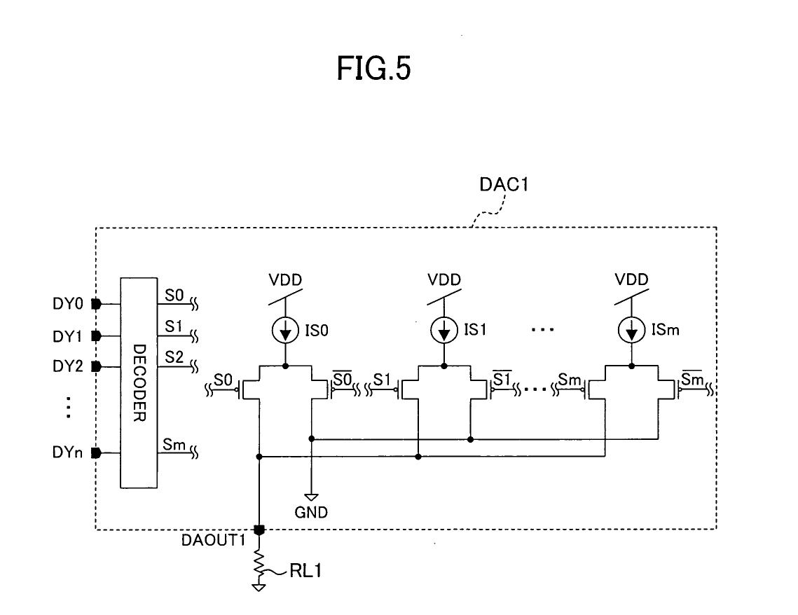

### EXPLANATION OF THE REFERENCE CHARACTERS

| | |
|---|---|
| 3 | Semiconductor integrated circuit |
| DAC5 | Current-steering differential-output D/A converter |
| DAOUT 5 | Non-inverting analog output terminal |
| NDAOUT5 | Inverting analog output terminal. |
| DY0 to DYn | Digital Y signal input terminal |
| DC0 to DCn | Digital C signal input terminal |
| DCOMP0 to | Digital COMP signal input terminal |
| DCOMPn | |
| RL1 to RL6 | Current-to-voltage converter |
| GND | Ground potential |
| AMP | Inverting amplifier |
| Yout | Analog Y signal output terminal |
| Cout | Analog C signal output terminal |
| COMPout | Analog COMP signal output terminal |

### BEST MODE FOR CARRYING OUT THE INVENTION

Hereinafter, embodiments of the present invention will be described with reference to the accompanying drawings.

### First Embodiment

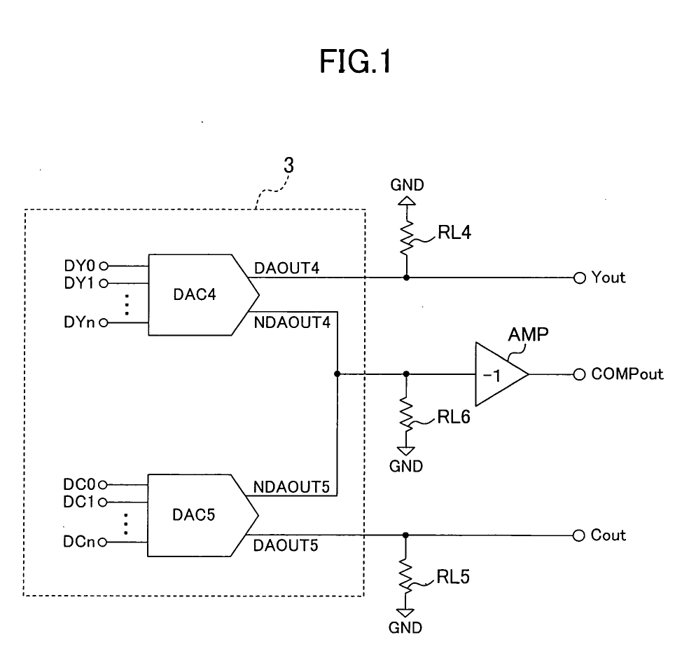

FIG. 1 is a schematic diagram illustrating an analog video signal generation circuit according to a first embodiment of the present invention.

In FIG. 1, a first D/A converter DAC4 is a differential-output current-steering D/A converter and has digital input terminals DY0 to DYn, a non-inverting analog output terminal DAOUT4, and an inverting analog output terminal NDAOUT4.

Likewise, a second D/A converter DAC5 is a differential-output current-steering D/A converter and has digital input terminals DC0 to DCn, a non-inverting analog output terminal DAOUT5, and an inverting analog output terminal NDAOUT5.

The inverting analog output terminal NDAOUT4 of the first D/A converter DAC4 and the inverting analog output terminal NDAOUT5 of the second D/A converter DAC5 are connected together, and the connection point thereof is connected to a first current-to-voltage converter RL6, which is a resistor and interposed between the connection point and a GND power source, while the connection point is also connected to the input terminal of an inverting amplifier AMP. The output terminal of the inverting amplifier AMP is connected with an analog video output terminal (a first video signal output terminal) COMPout.

Furthermore, the non-inverting analog output terminal DAOUT4 of the first D/A converter DAC4 is connected to a second current-to-voltage converter RL4, which is a resistor and interposed between the non-inverting analog output terminal DAOUT4 and the GND power source, while the non-inverting analog output terminal DAOUT4 is also connected with an analog video signal output terminal (a second video signal output terminal) Yout.

Likewise, the non-inverting analog output terminal DAOUT5 of the second D/A converter DAC5 is connected to a third current-to-voltage converter RL5, which is a resistor and interposed between the non-inverting analog output terminal DAOUT5 and the GND power source, while the non-inverting analog output terminal DAOUT5 is also connected with an analog video signal output terminal (a third video signal output terminal) Cout.

The analog video signal generation circuit thus configured according to this embodiment is incorporated into a TV, a car navigation system, a monitor, video equipment, a DVD device, or a next-generation DVD (Blu-ray, HD DVD, etc.) device, for example. The operation of the analog video signal generation circuit will be described below.

First, a set of digital luminance signals (Y signal) (first video signal), which is a set of digital video signals, is input to the digital input terminals DY0 to DYn and subjected to digital to analog conversion by the first D/A converter DAC4, and an analog luminance signal current is output from the non-inverting analog output terminal DAOUT4. The analog luminance signal current is converted into an analog luminance signal voltage by the resistor RL4 serving as a current-to-voltage converter, and the analog luminance signal voltage is output from the analog video signal output terminal Yout.

Likewise, a set of digital chroma signals (C signal) (second video signal), which is a set of digital video signals, is input to the digital input terminals DC0 to DCn and subjected to digital to analog conversion by the second D/A converter DAC5, and an analog chroma signal current is output from the non-inverting analog output terminal DAOUT5. The analog chroma signal current is converted into an analog chroma signal voltage by the resistor RL5 serving as a current-to-voltage converter, and the analog chroma signal voltage is output from the analog video signal output terminal Cout.

At the same time, an inverted analog luminance signal current is generated and is output from the inverting analog output terminal NDAOUT4 of the D/A converter DAC4, while an inverted analog chroma signal current is generated and is output from the inverting analog output terminal NDAOUT5 of the D/A converter DAC5. Since the inverting analog output terminals NDAOUT4 and NDAOUT5 of the two D/A converters DAC4 and DAC5 are connected together, the inverted analog luminance signal current and the inverted analog chroma signal current are added and synthesized into an inverted analog composite signal (composite video signal) current. The inverted analog composite signal current is converted into an inverted analog composite signal voltage by the resistor RL6 serving as a current-to-voltage converter, and the inverted analog composite signal voltage is inverted and amplified by AMP and then output from the analog video signal output terminal COMPout as an analog composite signal.

The analog luminance signal and the analog chroma signal are used in a pair as a video signal to display an image on video equipment, such as a TV, while at the same time the analog composite signal is used to display an image on different video equipment, such as a different TV.

As described above, the analog video signal generation circuit according to this embodiment synthesizes the COMP signal from the Y signal and the C signal, while effectively using the currents consumed by the D/A converters DAC4 and DAC5, thereby enabling video equipment to be realized at lower cost.

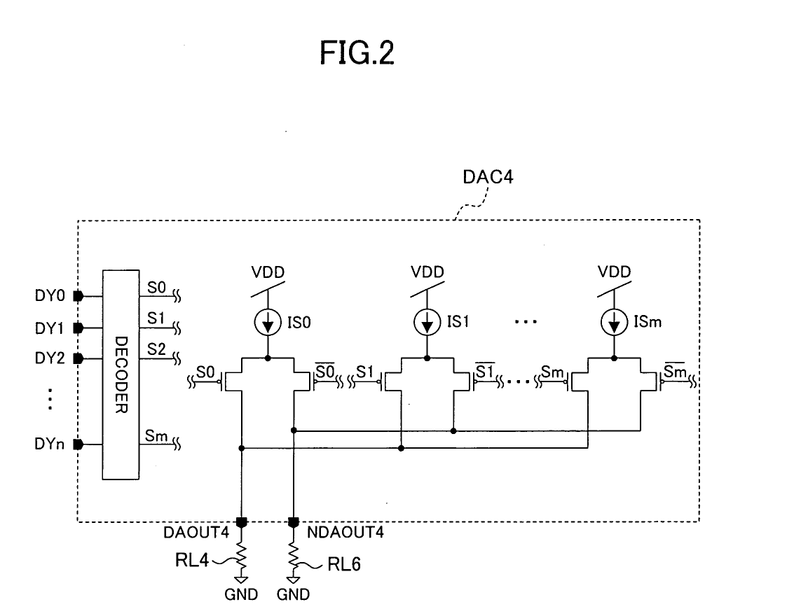

FIG. 2 shows an example of the configuration of the current-steering differential-output D/A converters DAC4 and DAC5 used in this embodiment.

FIG. 2 shows an example of the current-steering differential-output D/A converter DAC4. After input digital signals are decoded by a decoder DECODER to m+1 control signals (S0, /S0) to (Sm, /Sm), the signals (S0, /S0) to (Sm, /Sm) control a plurality of differential switches to thereby perform switching so as to determine whether each current from m+1 current sources IS0 to ISm flows to the non-inverting output terminal DAOUT4 or to the inverting output terminal NDAOUT4. When the currents are output to the non-inverting output terminal DAOUT4, the currents are consumed by the output load resistor RL4. When the currents are output to the inverting output terminal NDAOUT4, the currents are consumed by the output load resistor RL6. In both cases, the currents are used effectively.

In this manner, this embodiment produces the effect that the currents consumed by the D/A converters can be effectively used, together with the other effects.

In the above description, the inverting analog output terminals NDAOUT4 and NDAOUT5 of the first and second D/A converters DAC4 and DAC5 are connected together. Nevertheless, it will easily be appreciated that the non-inverting analog output terminals DAOUT4 and DAOUT5 may be connected together instead.

Moreover, in this embodiment, the D/A converters together with the digital circuits and the like are formed in a semiconductor integrated circuit 3. However, the other circuits, for example, RL4 to RL6 and AMP, may be formed in the semiconductor integrated circuit 3.

Also, in this embodiment, the inverting amplifier AMP is an amplifier with no gain, i.e., an amplifier producing −1 times amplification. Nevertheless, the inverting amplifier AMP may be an inverting amplifier with a gain other than 1. Furthermore, it would be evident that the inverting amplifier AMP may be replaced with a non-inverting amplifier.

In addition, the analog video signal generation circuit described in this embodiment uses the two current-steering differential-output D/A converters DAC4 and DAC5 to subject the set of digital luminance signals (the Y signal) and the set of digital chroma signals (the C signal) to digital to analog conversion and then adds and synthesizes signal currents to thereby generate the inverted analog composite signal. However, the present invention is not limited to the composite video signal synthesis thus performed, but an analog signal synthesizing circuit, which uses three or more current-steering differential-output D/A converters to subject three or more sets of digital signals to digital to analog conversion and then adds and synthesizes signal currents to thereby generate an analog signal, may also be used.

### INDUSTRIAL APPLICABILITY

As described above, the present invention allows a single analog signal to be generated by synthesizing from a plurality of digital signals, while effectively using currents consumed by current-steering D/A converters. Thus, the present invention is applicable to an analog video signal generation circuit, a semiconductor integrated circuit, video equipment, etc., whose component cost and hence price, and power consumption are reduced.

1. An analog video signal generation circuit comprising:
a first current-steering differential-output D/A converter, to which a first video signal is input;
a second current-steering differential-output D/A converter, to which a second video signal is input; and
a first current-to-voltage converter and an inverting or non-inverting amplifier, each connected to a connection point at which non-inverting or inverting output terminals of the first and second current-steering differential-output D/A converters are connected together,
wherein an output terminal of the inverting or non-inverting amplifier is a first video signal output terminal for outputting a composite video signal obtained by synthesis from the first and second video sets of signals.

2. The analog video signal generation circuit of claim 1, wherein the first video signal is a set of digital luminance signals, the second video signal is a set of digital chroma signals, and the composite video signal is an analog composite signal.

3. The analog video signal generation circuit of claim 1, wherein either the non-inverting or inverting output terminal of the first differential-output D/A converter that is not connected to the connection point is connected to a second current-to-voltage converter and to a second video signal output terminal; and
either the non-inverting or inverting output terminal of the second differential-output D/A converter that is not connected to the connection point is connected to a third current-to-voltage converter and to a third video signal output terminal.

4. The analog video signal generation circuit of claim 3, wherein the first differential-output D/A converter converts a set of digital luminance signals into an analog luminance signal;
the second differential-output D/A converter converts a set of digital chroma signals into an analog chroma signal; and
the first, second, and third video signal output terminals simultaneously output the analog composite signal, the analog luminance signal, and the analog chroma signal, respectively.

5. An analog video signal generation circuit formed on a semiconductor integrated circuit and comprising:
three or more current-steering D/A converters to which three or more sets of digital video signals are input, of the three or more current-steering D/A converters, first and second current-steering D/A converters being both differential-output D/A converters;
a first current-to-voltage converter and an inverting or non-inverting amplifier, each connected to a connection point at which non-inverting or inverting output terminals of the first and second current-steering differential-output D/A converters are connected together,
wherein an output terminal of the inverting or non-inverting amplifier is a first video signal output terminal for outputting a video signal obtained by analog synthesis in which an analog video signal is synthesized from the digital video signals input to the current-steering D/A converters.

6. An analog composite video signal generation method comprising the steps of:
generating an inverted analog luminance signal current from a set of digital luminance signals; and
generating an inverted analog chroma signal current from a set of digital chroma signals;
thereafter adding the inverted analog luminance signal current and the inverted analog chroma signal current together; and
subjecting the current obtained by the addition to current-to-voltage conversion and then to inverting amplification, thereby generating an analog composite video signal.

7. An analog signal synthesizing circuit comprising:
a plurality of current-steering differential-output D/A converters to which a plurality of digital signals are input; and
a resistor for current-to-voltage conversion and
an inverting or non-inverting amplifier,
each connected to a connection point at which non-inverting or inverting output terminals of the plurality of current-steering differential-output D/A converters are connected together,
wherein an output terminal of the inverting or non-inverting amplifier is an analog signal output terminal for outputting an analog signal obtained by analog synthesis in which—an analog signal is synthesized from the digital signals input to the current-steering differential-output D/A converters.

8. An analog signal synthesizing method comprising the steps of:
generating a plurality of inverted analog signal currents by subjecting a plurality of digital signals to digital-to-analog conversion and to inversion;
thereafter adding the plurality of inverted analog signal currents together; and
subjecting the current obtained by the addition to current-to-voltage conversion and then to inverting amplification, thereby generating an analog signal.

9. An analog signal synthesizing method comprising the steps of:
adding a first inverted analog signal current and a second inverted analog signal current; and
thereafter subjecting the current obtained by the addition to current-to-voltage conversion and then to inverting amplification, thereby generating an analog signal.

10. A semiconductor integrated circuit comprising the analog video signal generation circuit of claim 1.

11. Video equipment comprising the analog video signal generation circuit of claim 1.

12. A semiconductor integrated circuit comprising the analog video signal generation circuit of claim 6.

13. Video equipment comprising the analog video signal generation circuit of claim 6.
